(19) United States
(12) Patent Application Publication
(10) Pub. No.: US 2003/0107572 A1
(43) Pub. Date: Jun. 12, 2003

(54) Method and apparatus for reducing the polygon count of a textured, three dimensional model of an object

(76) Inventors: Joshua Edward Smith, Barre, MA (US); Anatoly F. Dedkov, Grafton, MA (US)

Correspondence Address: MINTZ, LEVIN, COHN, FERRIS, GLOVSKY, and POPEO, P.C., One Financial Center, Boston, MA, 02111, US

(21) Appl. No.: 10/188,217

(22) Filed: Jul. 1, 2002

Related U.S. Application Data
(60) Provisional application No. 60/302,573, filed on Jul. 2, 2001.
(60) Provisional application No. 60/315,407, filed on Aug. 28, 2001.

(51) Int. Cl. G06T 17/00

(52) U.S. Cl. 345/428

(57) ABSTRACT

The present invention describes a system and method for creating a textured, three dimensional model with a low polygon count from a source model having a high polygon count, while maintaining details of the model. The invention creates textures from the source model for polygons in the newly created model to maintain detail. In particular, a decimation technique is used to reduce the number of polygons from the source model to the resulting model. The system then renders sets of polygons, including textures, in the source model corresponding to each polygon in the resulting model. The rendered polygons are used to create textures for the resulting model.

### CROSS-REFERENCE TO RELATED APPLICATIONS

This application claims the benefit of priority to U.S. Provisional Applications Serial Nos. 60/302,573 and 60/315,407, filed Jul. 2, 2001 and Aug. 28, 2001, respectively, which are incorporated herein by reference in their entirety.

### STATEMENT REGARDING FEDERALLY SPONSORED RESEARCH

Not applicable.

### REFERENCE TO MICROFICHE APPENDIX

Not applicable.

### BACKGROUND OF THE INVENTION

The present invention is directed toward a system and method for transforming a three dimensional model into a different three dimensional model with a much lower polygon count. In particular, it relates to a system and method for maintaining detail of the model with enhanced texture images and a smaller number of polygons.

When one endeavors to represent a three dimensional object on a two dimensional displaying device, an important consideration is modeling the three dimensional object is to make it appear realistic. Typically, a three dimensional model is formed of two parts, a geometric structure formed of individual polygons and corresponding textures associated with each of the polygons. The representation of the objection should have realistic geometric proportions as well as having texture that makes it look like the actual object would appear in three dimensional space. When representing a three dimensional object, geometric information can be obtained from sources such as CAD modeling, photogrammetric analysis of actual photographs of the object, laser depth scanning of the actual object, and analysis of light patterns projected on the 3D object. Each of these techniques, when used with three dimensional rendering, provides an accurate representation of the object's geometry. However, when three dimensional models are created by NURBS-based CAD programs, laser scanning real objects, or similar techniques, they contain a very high polygon count.

Although models having a large number of polygons are very realistic representations of the objects they seek to model, the large number of polygons results in a large data file. In many applications, a model have a large data file is disadvantageous. For example, large data files utilize lots of storage space. They rendering of a model represented as a large data file with a high polygon count takes a longer amount of time. When the display of the model is modified or manipulated, it has to be rendered again. A large data file slows down the rendering application. Furthermore, it is more difficult to transfer a model with a large data file to other users or locations. Large capacity storage media is required if the model is physically transferred, or a longer time is required to electronically transfer the model. Therefore, a three dimensional model with low polygon counts is preferable for storage, rendering and transfer of the model. However, generally a model with a low polygon count appears less realistic when displayed.

Therefore, a need exists for a system which provides a realistic looking model having a low polygon count. A need exists for a system to create a three dimensional model that contains a much lower polygon count, but that looks nearly identical to a model having a higher polygon count. Finally, a need exists for a system which can create a lower polygon count model from a higher polygon count model while maintaining the realistic appearance of the rendering.

### SUMMARY OF THE INVENTION

The present invention substantially overcomes the deficiencies of the prior art by providing a system and method for reducing the polygon count of a model while maintaining the realistic appearance of the model. First, the system processes the geometric structure to obtain a model with a reduced polygon count. According to an embodiment of the invention, the system processes the geometric structure to determine vertices to remove from the structure. The vertices are selected based upon a determination of least change to the structure. In particular, two close vertices are removed and replaced with a single vertex between the original two. The polygons are adjusted to account for the changed vertices. The process is performed iteratively until the polygon count is reduced to a desired level.

Second, the system processes the texture information to create new textures for each of the polygons in the revised structure. According to an embodiment of the invention, each polygon in the new structure is analyzed to determine a set of polygons in the original structure covering the same area. Then, the set of polygons are rendered using any known rendering technique. The rendered set of polygons are used for the texture of the corresponding polygon in the revised model.

According to another feature of the present invention, the textures are encoded to provide an efficient storage mechanism. A tiling algorithm is used to lay the textures out in rows and columns. The tiles could be uniformly sized, using identically sized texture images, or, alternatively, variably sized. Each vertex in the geometric structure is associated with a texture coordinate within the tiled texture. The tiled texture is then encoded and stored. During rendering, the geometric structure is generated first. The textures are retrieved from the encoded, tiled texture and laid over the structure. According to another embodiment of the invention, multiple tiled textures are used for different sets of rendered textures.

According to another feature of the present invention, the system is deployed as program code stored on a general purpose computer. The program code may be in any desired language. According to an embodiment of the present invention, the code is implemented in JAVA programming language.

### BRIEF DESCRIPTION OF THE DRAWINGS

FIG. 1 illustrates a source model having a large number of polygons.

FIG. 2 illustrates a resulting model from the present invention corresponding to the source model of FIG. 1, having a reduced number of polygons.

FIG. 3 is a block flow diagram of the process of the present invention according to an embodiment of the present invention.

FIGS. 4a and 4b respectively illustrate portions of a source model and resulting model with texture.

FIG. 5 illustrates a tiled texture formed from a set of textures generated by an embodiment of the present invention.

### DETAILED DESCRIPTION

The present invention is directed toward a system and method for producing textured, high quality models of three dimensional objects. Three dimensional models are electronic representations of objects. A three dimensional model consists of a geometric structure of polygons and a textures associated with each of the polygons. In order to display the three dimensional model, a rendering algorithm is used to create a two-dimensional display from the three dimensional representation. The present invention can be implemented on any general purpose computer, such as a personal computer or server, with sufficient memory to store and manipulate three dimensional models. It can be implemented on a single, stand-alone computer, or as a part of a computer network, either local or global. The present invention can be implemented in various programming languages, as would be readily understood by one of ordinary skill in the art. According to an embodiment of the present invention, the steps of the present invention are created as a computer program in the JAVA programming language.

Additionally, the present invention could be implemented using three dimensional models in various formats. In a preferred embodiment, the three dimensional modelsare stored in a HyperSpace format, an internal format developed at Kaon Interactive, Inc. Alternatively, the models could be stored other known three dimensional formats, such as STL, PLY, or VRML 1.0. Furthermore, the original model and the resulting model from the present invention do not have to be in the same format. The system of the present invention can change the format during the revision process. According to an embodiment of the present invention, the source model includes texture and color. As discussed below, when the source model includes texture and color, this information is combined with an artificial lighting model to create the textures for the resulting model. Alternatively, the source model may just include a geometry. In which case, the artificial lighting model is used alone to generate the textures of the resulting model.

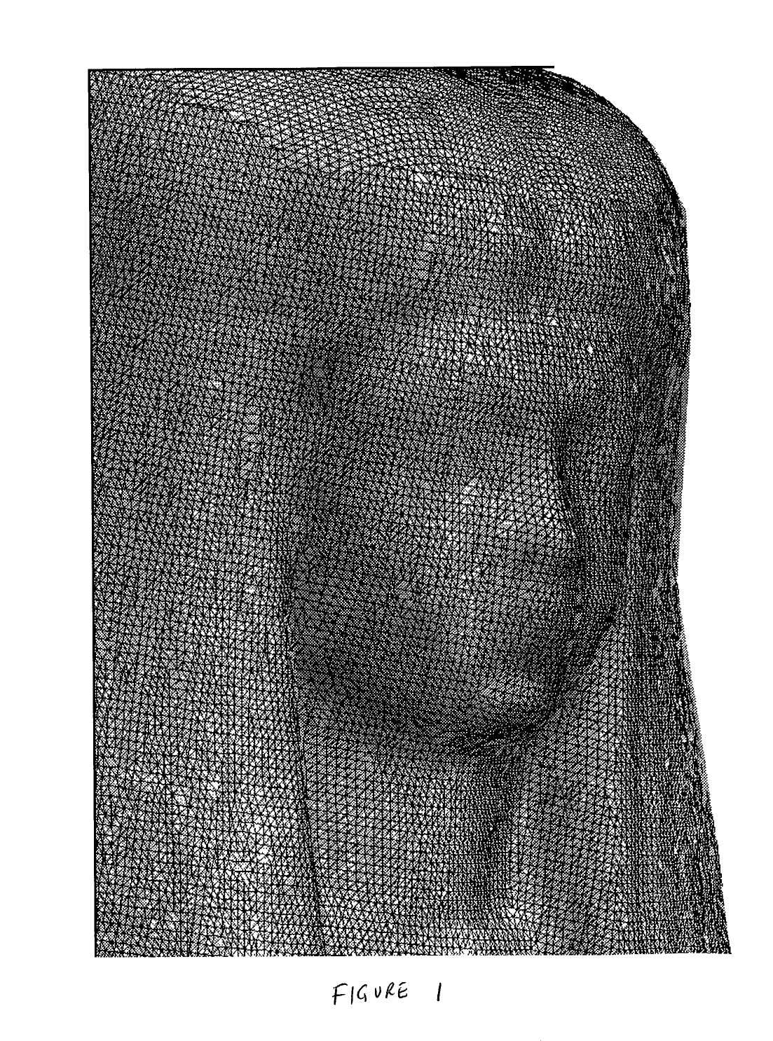

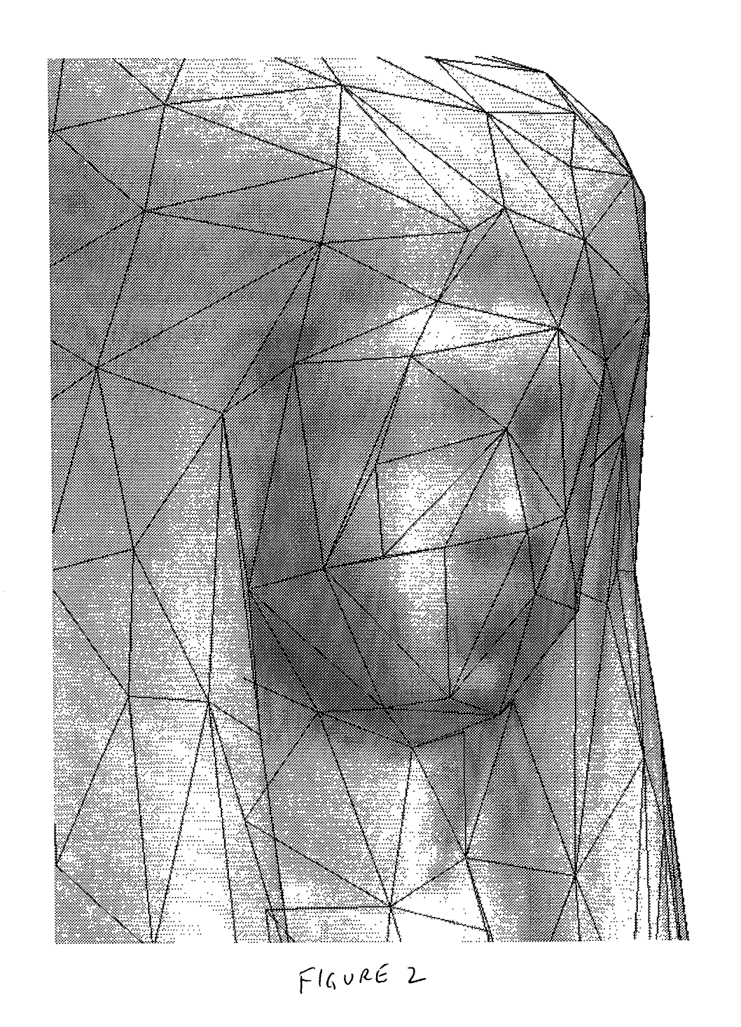

FIG. 1 illustrates a source model having a high polygon count. The source model can be created using various techniques. For example, the source model may be created with a CAD program, by laser scanning real objects, or by analysis of photographs. As noted above, the source model may include only geometry, as illustrated in FIG. 1, or may also include texture and color. The present invention creates a resulting model with a lower polygon count from the source model. FIG. 2 illustrates a resulting model corresponding to the source model of FIG. 1, but with a reduced polygon count. FIG. 2, as illustrated herein, does not include the texture creations techniques of the present invention. Thus, it does not truly represent a resulting model from the present invention, but merely the geometry of such a model.

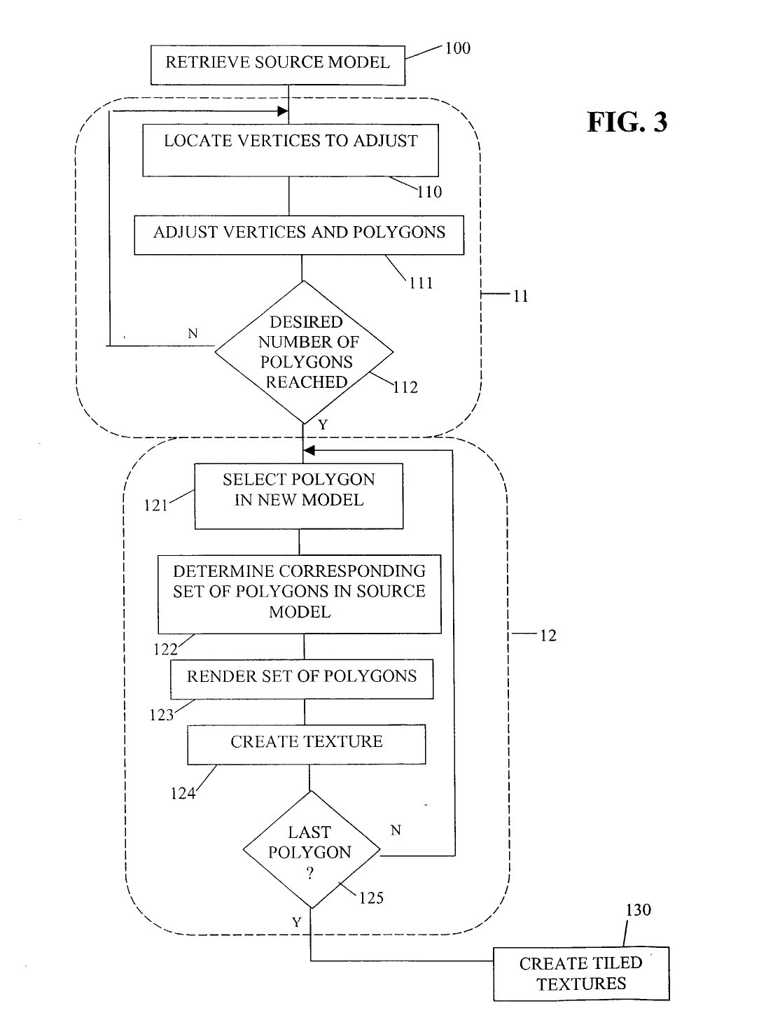

FIG. 3 illustrates a process 10 implementing the present invention. The process 10 includes two principal parts: polygon reduction 11 (including steps 110-112) and texture creation 12 (including steps 121-125). The first step in the process of the present invention is to create a geometry for the resulting model with a reduced polygon count. In terms of actually performing the transformation from a model containing a high number of polygons to a model with a low number of polygons, this transformation could be accomplished using any of a number of well known “decimation” techniques. The objective of a decimation technique is to reduce the number of polygons in a model by eliminating vertices and adjusting the polygons adjacent to the vertices, while maintaining as much as possible the model structure.

The typical steps of a decimation technique are illustrated in the polygon reduction step 11 of FIG. 3. First, the source model to which the technique is to be applied must be retrieved (step 100). Then, the model is analyzed to locate vertices to adjust, at step 110. In particular, the system determines two vertices which are closest. To determine the closest vertices, all pairs of vertices are compared to determine the which would result in the least distortion to the model if they were replaced by a vertex between the two. Once a closest set of vertices has been determined, the vertices and corresponding polygons are adjusted at step 111. In particular, the two closest vertices are replaced by a single vertex halfway between the two original vertices. The adjacent polygons are adjusted to correspond to the new vertex. At step 112, the number of polygons is compared to a desired number of polygons. If the desired number has been reached, the reduction process stops. Otherwise, the process returns to step 110 to locate and adjust another set of vertices. According preferred embodiment of the present invention, the system used the quadratic-based simplification algorithm or “QSlim” decimation technique created by Michael Garland, as set forth in Garland, Michael and Heckbert, Paul, Surface Simplification Using Quadric Error Metrics, SIGGRAPH 97, and Garland, Michael and Heckbert, Paul, Simplifying Surfaces with Color and Texture using Quadric Error Metrics, IEEE Visualization 98, both incorporated herein in their entirety by reference. According to another embodiment of the present invention, the quadratic-based simplification algorithm is implemented in Java. However, the present invention is not limited to this decimation technique or to any specific implementation of it. Alternatively, other well known decimation techniques, implemented in Java or in another programming language, could be utilized in the present invention. The present invention merely requires creation of a geometric structure corresponding to a source model but with a reduced number of polygons.

In a preferred embodiment, a user stipulates a goal for the number of polygons in the resulting model. The decimation technique is performed until that number of polygons is reached, as set forth in step 112. Alternatively, a default polygon count, such as 3000 polygons, could be used as the goal. In alternate embodiments, another type of metric, rather than a goal for the total number of polygons, could be used to determine when polygon reduction is complete. Irrespective of what criterion is used to provide information about when the polygon reduction should cease, the metric supplied could be specified through a text configuration file or an interactive user interface.

As noted above, once the polygon count has been reduced, new textures are created (FIG. 3, step 12) for each of the new polygons in order to maintain the detail of the model. FIG. 3 illustrates a preferred embodiment of the process for creating textures. The way in which the rendering environment is configured will affect the ability of the invention to ensure that each polygon in the resulting model has a sufficient amount of texture laid across it.

As illustrated in FIG. 3, the texture creation step 12 generates a rendering of the source model specific to each polygon in the resulting model. At step 121, a polygon in the resulting model is selected. At step 122, a determination is made of the polygons in the source model which correspond in location to the selected polygon in the resulting model. Only polygons from the source model that are somewhat coincident with the selected polygon in the resulting model are used in the texture creation process for the selected polygon. At step 123, a rendering algorithm is used to render the polygons from the source model. Preferably, the rendering is done by applying an artificial lighting model, as is known in the art. If the source model includes texture image or color, then the textures and colors are combined with the artificial lighting model during the rendering. If the source model includes only geometry, then the rendering is limited to the artificial lighting model. In either case, the resulting rendering is used as the texture for the selected polygon in the resulting model. Therefore, the texture image for a larger triangle in the resulting model is produced by rendering the smaller triangles from the source model when the smaller triangles share a space of overlap with the larger triangle. The rendering can also be done by using a technique called scan-line shading. Alternatively, a technique such as Ray Tracing could be used to render the polygons from the source model. Such rendering algorithms are described in detail in Foley, van Dam, Feiner, Hughes, “Fundamentals of Computer Graphics”, the contents of which are hereby incorporated by reference. In a preferred embodiment, the rendering algorithm is implemented in Java.

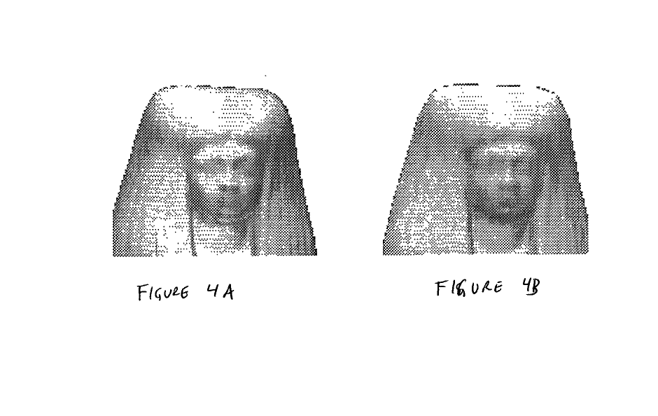

The rendering and texture creation process is repeated until textures have been created for all of the polygons in the resulting model, as determined at step 125. In this way, the resulting model has as many texture images as it has polygons. Alternatively, a single texture image could be generated for several adjacent polygons in the resulting model. In this manner, a smaller number of texture images would be generated. FIGS. 4a and 4b illustrate a source model and a corresponding resulting model created using the process of the present invention. The source model (FIG. 4a) contains more polygons than the resulting model (FIG. 4b). A similar level of detail is achieved in the resulting model from the application of additional textures.

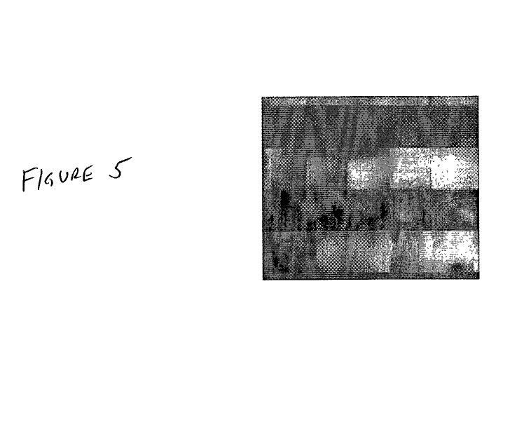

According to a preferred embodiment of the invention, all of the resulting texture images are encoded. This is done using a tiling algorithm, as set forth at step 130. The tiling algorithm lays out the texture images in rows and columns. In a preferred embodiment, all of the texture images are generated to be the same size, which results in uniformly sized tiles. FIG. 5 illustrates a set of tiles for texture images. In alternate embodiments, the size of the tiles could be based on various metrics, such as the size of the polygon being textured or on an input from the user.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A method for creating a textured, three dimensional model having a reduced polygon count from a source model, said method comprising the steps of:
applying a decimation technique to the source model to create the geometry of the textured, three dimensional model; and
creating a texture for each polygon in the geometry of the textured, three dimensional model based upon corresponding polygons in a geometry of the source model.

2. The method for creating a textured, three dimensional model according to claim 1, wherein the step of creating a texture includes the steps of:
determining a set of polygons in the geometry of the source model corresponding to a polygon the textured, three dimensional polygon;
rendering the set of polygons; and
storing the rendered set of polygons as a texture for the polygon in the textured, three dimensional model.

3. The method for creating a textured, three dimensional model according to claim 2, wherein the source model includes textures and wherein the rendering step includes rendering the textures for the set of polygons.

4. The method for creating a textured, three dimensional model according to claim 2, wherein the rendering step includes applying an artificial lighting model to the set of polygons.

5. The method for creating a textured, three dimensional model according to claim 1, wherein the step of applying a decimation technique includes the steps of:
receiving a value representing a desired size of the textured, three dimensional model; and
repeatedly applying the decimation technique until the desired size is obtained.

6. The method for creating a textured, three dimensional model according to claim 5, wherein the value representing the desired size of the textured, three dimensional model is a number of polygons.

7. The method for creating a textured, three dimensional model according to claim 1, further comprising the steps of:
tiling the textures created in the creating step; and
encoding the tiled textures

8. A system for creating a textured, three dimensional model having a reduced polygon count from a source model, the system comprising:
means for storing the source model;
means for applying a decimation technique to the source model to create a geometry of the textured, three dimensional model;
means for rendering a set of polygons in the source model corresponding to each polygon in the geometry of the textured, three dimensional model; and
means for storing the geometry of the textured, three dimensional model and textures created by the means for rendering.

9. The system for creating a textured, three dimensional model according to claim 8, further comprising means for rendering on a display the textured, three dimensional model.

10. The system for creating a textured, three dimensional model according to claim 8, wherein the means for rendering includes means for rendering textures in the source model for the set of polygons.

11. The system for creating a textured, three dimensional model according to claim 8, wherein the means for rendering includes means for applying an artificial lighting model to the set of polygons.

12. The system for creating a textured, three dimensional model according to claim 8, wherein the means for storing includes means for tiling the textures from the means for rendering.
